(19) United States
(12) Patent Application Publication
(10) Pub. No.: US 2006/0121855 A1
(43) Pub. Date: Jun. 8, 2006

(54) System and method for adjusting a range of access for a cell

(75) Inventor: Matt J. Dillon, Hawthorn Woods, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC.

(21) Appl. No.: 11/006,183

(22) Filed: Dec. 7, 2004

(51) Int. Cl. H04Q 7/20

(52) U.S. Cl. 455/69; 455/68

(57) ABSTRACT

A communication device includes a processor, configured to facilitate first determining locations and signal strength levels corresponding to one or more communication units (107) in a cell (109) of at least one base station (101); second determining, responsive to the first determining, a target range (111) for the cell based on the locations and the signal strength levels; and adjusting an access range of the cell toward the target range (111). Optionally, a shrinkage of the range can be prevented so as to continue to encompass the communication unit(s) (107) within the range.

### FIELD OF THE INVENTION

The present invention relates in general to wireless communication units and wireless networks, and more specifically to providing an appropriate access range for a communication system.

### BACKGROUND OF THE INVENTION

Currently, a radius defining an access range for a communication system, such as encountered in a code division multiple access (CDMA) system, is determined by a system engineer, which is informed by drive testing and includes the engineer's estimation of an appropriate access range. If a cell radius is insufficient, attempts by a mobile device to initiate a call on or to respond to a page from the corresponding cell or cell site will not be received or properly interpreted by a base transceiver station (BTS) when the mobile device or user equipment is located outside the cell radius, e.g., a signal from the device falls outside of a cell search window.

Conventional methods for identifying an appropriate cell access range require drive testing. In a drive testing process, technicians drive through areas in proximity to various cells with equipment configured to study network connectivity, and they collect data regarding cell sites and connectivity. Typically, the data that is collected is analyzed later and any troubleshooting of problems that are identified occurs thereafter.

Two general strategies or methods of drive testing and analysis are conventionally provided. One traditional method of drive testing is manual. It requires a technician to drive to the problem area and collect data and interpret it on the spot or manually bring the data back to the office for analysis. Another method, which is partially automated, can combine manual drive testing and analysis with automatic data analysis. In the partially automated method, data is collected via drive testing and can be stored on a centralized file server. Available software tools can output reports, maps and analysis of connectivity.

Communication network problems relating to cell size can increase where the density and number of cells are increased. As communication technologies evolve, more testing may be needed to ensure that a desired level of quality is achieved. However, the conventional type of data gathering including drive testing can be time consuming and expensive due to the personnel and vehicles that can be involved.

### BRIEF DESCRIPTION OF THE DRAWINGS

The accompanying figures, where like reference numerals refer to identical or functionally similar elements and which together with the detailed description below are incorporated in and form part of the specification, serve to further illustrate exemplary embodiments and to explain various principles and advantages in accordance with the present invention.

FIG. 1 is a diagram illustrating a simplified and representative environment associated with a first exemplary wireless network having an adjusted cell access range and a communication unit in accordance with various exemplary embodiments;

FIG. 2 is a diagram illustrating a simplified and representative environment associated with a second exemplary wireless network having an adjusted cell access range and a communication unit in accordance with various exemplary embodiments;

FIG. 3 is a block diagram illustrating portions of an exemplary infrastructure device supporting an adjusted cell access range in accordance with various exemplary embodiments; and

FIG. 4 is a flow chart illustrating an exemplary cell access range adjustment procedure in accordance with various exemplary and alternative exemplary embodiments.

### DETAILED DESCRIPTION

In overview, the present disclosure concerns communications systems often utilized in connection with wireless communication units, such as cellular phone or two-way radios and the like. The communication units can be associated with a communication system such as an Enterprise Network, a cellular Radio Access Network, or the like. Such communication systems can include various infrastructure devices or equipment, sometimes alternatively referred to herein as communication devices, and may further provide services such as voice and data communications services. More particularly, various inventive concepts and principles are embodied in systems, communication devices, communication units, and methods therein for adjusting an access range or cell access range, e.g., distance, for a communication infrastructure device in connection with communications to and/or from a communication unit.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore or application specific ICs. Where appropriate, the processor can be, for example, a general purpose computer, can be a specially programmed special purpose computer, can include a distributed computer system, and/or can include embedded systems. Similarly, where appropriate, the processing could be controlled by software instructions on one or more computer systems or processors, or could be partially or wholly implemented in hardware. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

As further discussed herein below, various inventive principles and combinations thereof are advantageously employed to address the problem of determining cell access range without drive testing, in order to appropriately increase and/or decrease or reduce cell access range, thus cell area.

Further in accordance with exemplary embodiments, there is provided a system and method for adjusting, e.g. attempting to optimize cell access range. In general the objective is to reduce as much as possible the number of missed calls, minimize needless interference, and operate all parts of the system in an efficient manner all of which are facilitated by a proper access range. Thus it is desired to adjust the access range for a given cell to correspond, for example, to the radio or radio frequency (RF) coverage range for that cell or the corresponding base station at least for a relevant portion of the area represented by the cell. The RF coverage range depends on a variety of factors including power output from the base station, interference levels from neighbor cells or base stations, antenna configurations, and radio signal propagation characteristics within the relevant geographic area. The radio propagation characteristics and interference levels vary with known environmental factors such as weather, seasonal changes, construction activities and resultant structures and the like as well as the placement and number of neighbor cells.

The access range or cell access range is controlled by adjusting at a base station or other controlling entity a parameter corresponding to a search window. The search window corresponds to the maximum or near maximum possible propagation delays that can be seen when a base station is communicating with a mobile or portable communication unit and this corresponds to the range or distance between the base station and the communication unit. Thus by increasing the search window the access range can be increased. Similarly the access range can be decreased by decreasing the search window. However, as the search window is increased the time required for a searcher to scan or look for signals in the search window increases as is known.

To compensate for the additional search time, systems as part of a forward channel protocol may direct communications units to increase the length of a preamble message that is provided by the communication unit and searched for by a searcher at a base station when a call is originated or page is responded to by the communication unit. For example, in one embodiment of a Wideband CDMA base station the search window can be adjusted from a low time limit to a high time limit (limits will vary according to specific techniques as will be appreciated by those of ordinary skill) and this corresponds to an access range from a to b miles. As the search window is adjusted the corresponding preamble length in terms of frames is adjusted via the forward channel messages. When the search window is to small (access range too low or short), possible traffic is missed since communications units are not within the access range and when the search window is too large preamble sizes may be too large or long resulting in excess call setup latency and excess call setup failures.

Measurements such as signal strength utilized by one or more embodiments can be collected, such as is done with conventional technology, as further detailed below. An examination of call locations (communication unit locations when a call or other communication is undertaken) and signal strength measurements can be utilized to determine an appropriate cell access range for a particular cell. The cell access range can be adjusted accordingly. Where the radius of a cell corresponding to a cell access range or access range is decreased, one or more embodiments provide that the decrease is limited to accommodate currently connected communication units. Hence, the adjustment of cell access range can be performed methodically and automatically. Because the adjustment can be performed as frequently as desired, cell access range can be more closely or more nearly optimized.

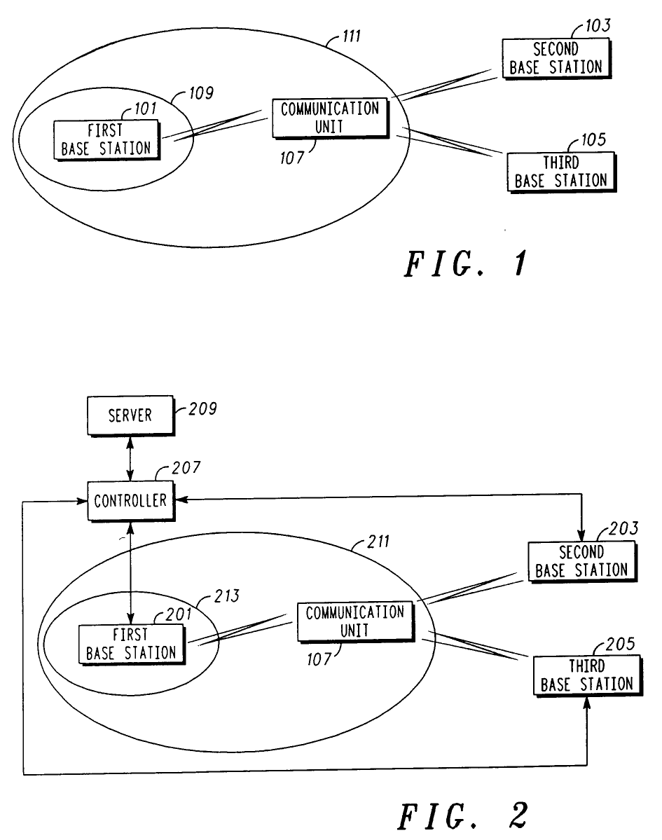

Referring now to FIG. 1, a diagram illustrating a simplified and representative environment associated with a first exemplary wireless network having a cell access range that can be adjusted and possibly “optimized” and a communication unit will be discussed and described. In overview, the illustrated embodiments shows a first base station 101, a second base station 103, and a third base station 105. The first base station 101, representative of numerous base stations that can be included in a communications network, has a current cell access range 109 (depicted as the closed line 109 having a particular radius, i.e. distance from base station 101). A communication unit 107 outside or beyond the current cell access range 109 will not be able to access, e.g. will not be acknowledged by, the first base station 101, even if the communication unit 107 is within radio frequency range from a signal power or signal to total noise plus interference perspective. For example, if a call is initiated, i.e. attempted, by the communication unit 107, or if a page is sent to and thus expected to be received by the communication unit 107, the first base station 101 will not detect or observe any call origination signals or page acknowledgment messages and thus will not provide communications to the communication unit 107.

Nevertheless, the communication system has information collected from the communication unit 107 or other communication units. For example, the communication system conventionally collects call detail information, providing details of a call. Call details are transmitted from a communication unit (typically at the end of a call) to infrastructure devices, are collected from infrastructure devices, are stored, and can be retrieved to support external operational systems, such as billing systems.

Useful information that can be collected from call details and can be stored in a call detail log includes, for example, phase delay measurements. A phase delay measurement can reflect a difference in timing of phased transmissions received by the communication unit from base stations that are in range.

In addition, a base station can collect access delay information reflecting a delay of a transmission from the base station to communication units that are in range. An access delay measurement typically is measured between arriving access correlation peaks, as is known, sometimes referred to in certain technologies as a pseudo noise (PN) offset. Note that phase delay is a measurement made by the communication units and compares observed time from multiple base stations. Access delay is a measurement by one base station of essentially propagation delay from the unit to the base station.

Information that is automatically collected from the communication unit 107 can be utilized to determine a location thereof. Such information can be ascertained from, e.g., phase delay measurement data and/or global positioning system (GPS) data. Conventionally, a communication unit that is traveling through an area also transmits messages reflecting the phase delay measurement to an infrastructure device related, for example to a hand-off to another infrastructure device. In one embodiment, a phase delay measurement included in a message can be referred to as or obtained from a pilot strength measurement message (PSMM). Phase delay can be utilized, e.g., such as by triangulation, to indicate a location from or relative to one or more particular infrastructure devices.

In the illustrated example, communication unit 107 has provided phase delay information to the first base station 101, the second base station 103, and the third base station 105. A technique can be used to determine a location of a communication unit utilizing, e.g., triangulation. A communication unit's location alternatively can be specified using GPS data, if such information is available and tracked.

Although the current cell access range 109 does not allow the first base station 101 to communicate with the communication unit 107, it might be possible and appropriate to expand or increase the radius of the cell, e.g. access range 109 for example up to a cell access range 111 (depicted as the closed line 111 with a corresponding radius). This increase in access range would be appropriate and possible, for example, if radio coverage or signal power to noise plus interference levels were sufficient to provide service to communication units operating within the closed line 111 over at least a relevant portion, e.g. a sector, of the corresponding area. The increased or larger access range 111, i.e. server radius now encompasses the illustrated communication unit 107 and thus communications with base station 101 will be possible or permitted. In other words, the radius corresponding to the current cell access range 109 might be too small.

It can be determined that the cell access range 109 could be expanded by examining information collected regarding locations and corresponding signal strengths from or for various communication units. Accordingly, one or more embodiments provides that the infrastructure device is configured to facilitate first determining locations and signal strength levels corresponding to one or more communication units in a cell of at least one base station; second determining, responsive to the first determining, an appropriate access range or target range for the cell based on the plurality of locations and the plurality of signal strength levels; and adjusting the access range of the cell toward the target range. Details relating to the first and second determining and the adjusting are provided by way of example in the following sections.

An appropriate radius of a cell, i.e. access range or target range for a particular base station, can be determined based on phase delay measurements. One way of determining a better server radius or target range for a serving base station, by way of example, can include identifying locations determined from phase delay measurements with corresponding sufficient signal strength, where:
signal strength=chip energy/interference level.

Signal strength at various locations can be sorted in accordance with known statistical techniques, outliers and other statistical anomalies can be eliminated, and a more appropriate cumulative distribution function (CDF) line can be determined. Accordingly, locations within a target range or appropriate access range can be determined from one or more phase delay measurements.

Phase delay measurements and corresponding signal strength measurements that are collected can be stored for later use. For example, in one or more embodiments, the phase delay and signal strength measurements are collected as pilot strength measurement messages (PSMM), and then are stored. In the example of FIG. 1, the phase delay and signal strength measurements are collected by and/or are distributed to the first base station 101, and are stored locally. Advantageously, phase delay and signal strength measurements from multiple base stations can be stored in one or more centralized locations (as illustrated and described in further detail in connection with FIG. 2). The one or more phase delay measurements or signal strength can be retrieved from storage, (e.g. at the base station, centralized locations, or the like) of the phase delay and signal strength measurements.

The locations that are encompassed within a possible cell access range of the first base station 1 0 1 can be determined by examining the collected information for locations that communicate with the first base station. For example, the locations can be determined from pilot strength and phase offset information corresponding to the communication unit 107 (and possibly other communication units).

It may be desirable to provide a cell access range or target range that is smaller than the largest possible cell access range. For example, a signal at the outermost edges of the largest possible cell access range might be undesirably low in terms of signal strength according to established standards. Accordingly, it is possible to omit locations that are too distant, when determining a best radius or target access range for the cell. It can be advantageous to statistically sort the locations, in order to readily omit locations which are too distant. Accordingly, the second determining can comprise a statistical sorting of the plurality of locations.

According to one or more embodiments, the locations can be determined from access delay measurements. Access delay measurements have been described above.

In changing the radius of a cell access range to meet the target range or radius determined as explained above, the radius can be increased, and/or can be decreased, in accordance with the techniques noted above, as is appropriate. It is anticipated that the radius will be promptly adjusted, although a gradual increase or decrease is possible. Hence, one or more embodiments provide that an access range, (size of the cell) is increased to the target range or radius, and/or that the access range of the cell is decreased to the target range or radius.

Particularly, when decreasing the cell access range, it can be desirable to ensure that the decrease does not cause a current communication unit to drop a call that is in progress. Consider, for example, that the first base station 101 has a cell access range corresponding to the outer cell access range 111. If it is determined that the best size of the cell is actually at the inner cell access range 109, it would be undesirable to adjust the radius and lose communication with the communication unit 107. Thus, one or more embodiments provide for a third determining of the location of one or more communication units in the cell, and adjusting the access range to encompass the communication unit(s).

Referring now to FIG. 2, a diagram illustrating a simplified and representative environment associated with a second exemplary wireless network having an adjusted or adjustable cell access range and a communication unit will be discussed and described. Descriptions of elements which can be substantially the same as provided in connection with FIG. 1 are omitted for simplicity.

In overview, FIG. 2 illustrates a network or base station controller (controller) 207, and a server 209. The communication unit 107 is within an outermost cell access range 211 of the first base station 201, but outside of an inner cell access range 213. The controller 207 in the present example communicates with a first base station 201, a second base station 203 and a third base station 205. In the present example, the base stations 201, 203, 205 can provide information to the controller, which can perform a function of collecting the information from multiple base stations 201, 203, 205, and optionally storing the information in the server 209. The controller 207 and the server 209 can be implemented in connection with conventional network infrastructure devices, e.g., a base station controller (BSC) and servers such as an operations maintenance center (OMC) or other network infrastructure devices that support network operations and maintenance tasks. Alternatively, the controller 207 can maintain collected information locally.

A method of adjusting an access range or radius of a cell, according to one or more embodiments can include, in overview, determining locations corresponding to one or more communication units in a cell of one or more base stations; determining a target range for the cell, responsive to the locations; and adjusting the access range for the cell toward the target range (or target access range). Examples of determining locations have been described above, as well as ways for determining an access range or corresponding radius for the cell and adjusting the cell accordingly. The controller 207 can conveniently determine the locations, e.g., from information stored in the server 209, determine an appropriate radius or target range, and provide appropriate instructions to adjust the access range of the first base station 201 or other base stations.

Determining the locations can include, for example, obtaining the locations from one or more phase delay measurements. Phase delay measurements can provide delays of phased transmissions from various base stations, e.g., the first base station 201, the second base station 203, and the third base station 205, to the communication unit 107. A standard triangulation of the phase delay measurements can yield a location of the communication unit 107. (Note that the location can be provided in various ways, e.g., in absolute position, or relative to another fixed (or mobile) location.)

Moreover, the phase delay measurement(s) can be retrieved from a storage of phase delay measurements. In the illustrated embodiment, for example, the controller 207 can retrieve the phase delay measurements from the server 209.

In accordance with one or more embodiments, the locations can be determined from pilot strength and phase offset information. Pilot strength and phase offset information has been previously discussed.

The signal strength levels can be analyzed, e.g., to determine strength of a signal in correspondence to various locations and/or base stations. Further, the signal strength levels can be ranked, e.g., by a sorting, and optionally utilizing known statistical techniques. The ranking can enable the omission of outliers, and/or the omission of distances which are too far from the base station (e.g., compared to a threshold) or which undesirably overlap with another base station. In accordance with one or more embodiments, determining the radius or target access range can include an analysis and ranking of signal strength levels corresponding to the locations.

When adjusting the radius or target range downward so that the cell becomes smaller, it is undesirable to shrink the cell size so that current users with a call in progress are dropped off. Current distances of current users can be ascertained, such as from an access delay measurement. Shrinkage of the cell size can be prevented so that the radius encompasses at least the distances of current users. Accordingly, one or more embodiments provides for preventing a shrinkage or reduction of the radius or target range so as to continue to encompass communication unit(s) within the current access range or radius.

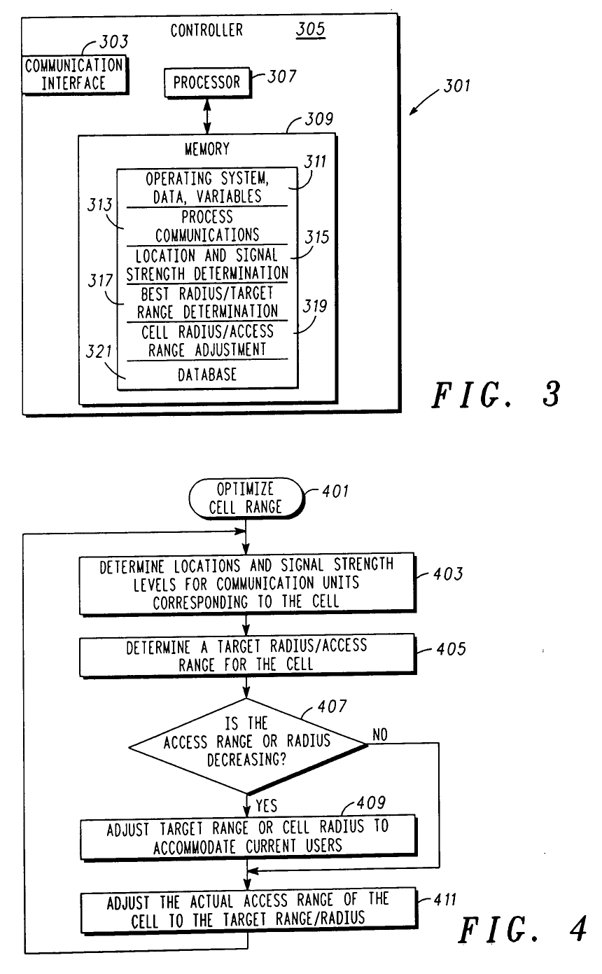

Referring now to FIG. 3, a block diagram illustrating portions of an exemplary infrastructure device supporting an adjusted cell access range in accordance with various exemplary embodiments will be discussed and described. FIG. 3 is a diagram illustrating an exemplary communication device 301 in an exemplary communication network, e.g., a radio access network arranged for providing, e.g., cellular telephone support, in accordance with various exemplary embodiments. As explained previously, the communication device 301 may be included in an infrastructure device, for example, the base station discussed above and/or the controller discussed above, where the infrastructure device is provided with an appropriate ability to communicate and to have access to the desired information. The communication device 301 may include one or more controllers 305, and a communication interface 303 for communicating over the communication network. The controller 305 as depicted generally comprises a processor 307, a memory 309, and may include various other functionality that is not relevant but will be appreciated by those of ordinary skill in the art.

The processor 307 may comprise one or more microprocessors and/or one or more digital signal processors. The memory 309 may be coupled to the processor 307 and may comprise one or more of a read-only memory (ROM), a random-access memory (RAM), a programmable ROM (PROM), an electrically erasable programmable read-only memory (EEPROM) and/or magnetic or optical memory or the like. The memory 309 may include multiple memory locations for storing, inter alia, an operating system, data and variables 311 for programs executed by the processor 307. The memory 309 can include locations for computer programs for causing the processor to operate in connection with various functions such as processing communications to/from other network elements or communication units 313 (as appropriate), determining location and signal strength 315, determining a best radius or target range for a cell 317, causing the radius or access range of the cell to be adjusted 319, and/or other processing; and a database 321 of other information used by the processor 307. The computer programs direct the processor 307 in controlling the operation of the communication device. The computer programs 313-319 are further described below by way of example.

Communications to/from other network elements or communication units can be processed 313 in one or more known manners. Responsive to signaling received from the communication interface 303, or in accordance with instructions stored in memory 309, the processor 307 may handle communications, for example, a message or streaming data including information relevant to a determination of a communication unit location. In accordance with one or more embodiments, the message or streaming data can automatically cause the processor 307 to monitor and/or adjust the range or access range of a cell. Alternatively, a message or streaming data can include a specific direction to the processor to adjust the range of a cell. Adjusting the range of a cell has been described in detail above. Where appropriate, communications can be made between the server, the controller, the base stations, and communication units in accordance with known techniques.

Moreover, the processor 307 can be programmed for determining location and signal strength 315, as described previously. Information regarding the location and signal strength can be utilized in connection with determining a target range or best radius to be applied to a particular cell. The processor 307 can be programmed for determining a target range or best radius for a cell 317, as described previously. In addition, the processor 307 can be programmed for causing the cell radius or access range to be adjusted 319. Various techniques are known and were described above for instructing the cell radius to be changed, i.e. adjusting an access range of the cell. This adjusting can utilize an operations maintenance center (OMC) and one or more standard inputs to the OMC.

A test utilizing a prototype of one or more embodiments was performed on data acquired from a communication network system in China. The test demonstrated that some cells in the communication network appear to be missing as much as 10% of the traffic with which they should be used, due to an insufficient radius or cell access ranges. On the other hand, the test showed that some cells have a radius which is much too large, thereby undesirably increasing a size of a preamble. When the preamble is too large, a delay is caused which can be a primary cause of call setup failure.

FIG. 4 is a flow chart illustrating an exemplary cell access range optimization procedure 401 in accordance with various exemplary and alternative exemplary embodiments. The procedure can advantageously be implemented on, for example, a processor of a controller, described in connection with FIG. 3 or other apparatus appropriately arranged.

The exemplary cell optimization or adjustment procedure 401 provides for determining 403 locations and signal strength levels for communication units corresponding to a cell that is of interest. For example, location measurements can be collected, as described previously in detail.

A server radius or target access range for a serving base station can be determined 405 that is appropriate for the cell. This determination can be made, for example, in response to the location measurements in relation to the base station of the cell that is of interest.

The cell access range adjustment procedure 401 includes modifying the range, e.g., the radius of the cell to the newly determined access range or target range with a corresponding radius. Depending on the current situation, the modification could be an increase in the access range or of the cell radius, or a decrease in the access range or of the cell radius, to the newly determined cell access range or target range. It may be desirable to prevent an over-shrinkage of the cell access range so that current users are not dropped.

Accordingly, the procedure can provide for determining 407 whether the access range or radius is decreasing. If it is decreasing, the procedure can adjust 409 the determined cell radius or target range to accommodate current users in the current cell access range. For example, the procedure can determine access delay measurements corresponding to the cell; and can limit the decrease so as to include one or more active communication units within the new access range of the cell.

In any event, the procedure provides for adjusting 411 the actual access range or radius of the cell to the target range or newly determined radius. The access range can be adjusted in accordance with known techniques that provide a corresponding adjustment of the cell radius.

It should be noted that the term communication unit may be used interchangeably herein with subscriber unit, wireless subscriber unit, wireless subscriber device or the like. Each of these terms denotes a device ordinarily associated with a user and typically a wireless mobile device that may be used with a public network, for example in accordance with a service agreement, or within a private network such as an enterprise network. Examples of such units include personal digital assistants, personal assignment pads, and personal computers equipped for wireless operation, a cellular handset or device, or equivalents thereof provided such units are arranged and constructed for operation in different networks.

The communication systems and communication units of particular interest are those providing or facilitating voice communications services or data or messaging services over cellular wide area networks (WANs), such as conventional two way systems and devices, various cellular phone systems including analog and digital cellular, CDMA (code division multiple access) and variants thereof, GSM (Global System for Mobile Communications), GPRS (General Packet Radio System), 2.5G and 3G systems such as UMTS (Universal Mobile Telecommunication Service) systems, Internet Protocol (IP) Wireless Wide Area Networks like 802.16, 802.20 or Flarion, integrated digital enhanced networks and variants or evolutions thereof.

Furthermore the wireless communication units or devices of interest may have wireless communications capability normally referred to as WLAN (wireless local area network) capabilities, such as IEEE 802.11, Bluetooth, or Hiper-Lan and the like preferably using CDMA, frequency hopping, OFDM (orthogonal frequency division multiplexing) or TDMA (Time Division Multiple Access) access technologies and one or more of various networking protocols utilizing high speed and/or high bandwidth technologies and techniques.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A communication device comprising:
a processor, configured to facilitate first determining a plurality of locations and a plurality of signal strength levels corresponding to at least one communication unit in a cell of at least one base station; second determining, responsive to the first determining, a target range for the cell based on the plurality of locations and the plurality of signal strength levels; and adjusting an access range for the cell toward the target range.

2. The communication device of claim 1, wherein the plurality of locations are determined from at least one phase delay measurement.

3. The communication device of claim 2, wherein the at least one phase delay measurement is retrieved from storage of a plurality of phase delay measurements.

4. The communication device of claim 1, wherein the plurality of locations are determined from pilot strength and phase offset information corresponding to a plurality of communication units.

5. The communication device of claim 1, wherein the second determining further comprises a statistical sorting of the plurality of locations.

6. The communication device of claim 1, wherein the processor is utilized in a controller for a communication system.

7. The communication device of claim 1, further wherein the plurality of locations are determined from access delay measurements.

8. The communication device of claim 1, wherein the access range for the cell is increased to the target range.

9. The communication device of claim 1, wherein the access range for the cell is decreased to the target range.

10. The communication device of claim 9, further comprising third determining of the location of the at least one communication unit in the cell, and adjusting the target range to encompass the at least one communication unit.

11. A method of adjusting a range of a cell, comprising:
first determining a plurality of locations corresponding to at least one communication unit in a cell of at least one base station;
second determining a range for the cell, responsive to the first determining, based on the plurality of locations; and
adjusting the cell toward the range.

12. The method of claim 11, wherein the first determining comprises obtaining the plurality of locations from a plurality of phase delay measurements.

13. The method of claim 12, further comprising retrieving the plurality of phase delay measurement from storage of a plurality of phase delay measurements.

14. The method of claim 11, further comprising determining the plurality of locations from pilot strength and phase offset information.

15. The method of claim 11, wherein the second determining further comprises an analysis and ranking of a plurality of signal strength levels corresponding to the plurality of locations.

16. The method of claim 11, further comprising preventing a shrinkage of the range so as to continue to encompass the at least one communication unit within a current range.

17. The method of claim 11, wherein the plurality of locations are determined from access delay measurements corresponding to the at least one communication unit.

18. A method of adjusting cell range, comprising:
collecting a plurality of location measurements;
determining a server target range for a cell, responsive to the plurality of location measurements in relation to a base station of the cell; and
modifying a range of the cell to be the server target range.

19. The method of claim 18, wherein the modifying comprises at least one of increasing and decreasing the range of the cell to the server target range.

20. The method of claim 19, further comprising determining a plurality of access delay measurements corresponding to the cell; and limiting the decreasing to include at least one communication unit in the cell.
